(19) United States
(12) Patent Application Publication
(10) Pub. No.: US 2019/0392535 A1
(43) Pub. Date: Dec. 26, 2019

(54) GENERATING VALUATION GAIN USING SEASONALITY DATA

(71) Applicants: Nelson Chan Ray, San Francisco, CA (US); David Makanalani Lundgren, San Francisco, CA (US); Dale Yut Jung Everett, San Francisco, CA (US); Carolina Marquez, San Francisco, CA (US); David Anthony Sinsky, Oakland, CA (US); Leonid Boris Pekelis, San Francisco, CA (US); Emily Louise Fay, Orinda, CA (US); Xinlu Huang, Palo Alto, CA (US)

(72) Inventors: Nelson Chan Ray, San Francisco, CA (US); David Makanalani Lundgren, San Francisco, CA (US); Dale Yut Jung Everett, San Francisco, CA (US); Carolina Marquez, San Francisco, CA (US); David Anthony Sinsky, Oakland, CA (US); Leonid Boris Pekelis, San Francisco, CA (US); Emily Louise Fay, Orinda, CA (US); Xinlu Huang, Palo Alto, CA (US)

(21) Appl. No.: 16/448,754

(22) Filed: Jun. 21, 2019

Related U.S. Application Data
(60) Provisional application No. 62/688,684, filed on Jun. 22, 2018.

(51) Int. Cl. G06Q 50/16; G06Q 30/02

(52) U.S. Cl. CPC G06Q 50/16; G06Q 30/0201; G06Q 30/0278

(57) ABSTRACT

Systems and methods are disclosed for determining a valuation gain amount by receiving, by a server data corresponding to previously sold real-estate property listing is retrieved from a market database and calculating valuation data for each of the previously sold real-estate property listings for portions of a specified time period. Seasonality data is further extracted from the valuation data for each of the portions. The system receives adjustments from a client device to the seasonality data. The adjustments may relate to future real-estate property trends. A plurality of valuation gain amounts for a new real estate property listing is determined based on the adjusted seasonality data. The system generates a visualization representing a graphical trend and causes presentation of the visualization on a graphical user interface of a client device.

### CROSS-REFERENCE TO RELATED APPLICATION

This application claims the benefit of priority of U.S. Provisional Patent Application No. 62/688,684, entitled “PREDICTION MODELING SYSTEM,” filed on Jun. 22, 2018, the entirety of which is hereby incorporated by reference herein.

### BACKGROUND

Determining a value for a home or a final resale price for a home can be technically challenging based on the variety of potential factors (e.g., features of the home, timing of the sale, location of the home, etc.) that can affect a final sale of the home. Moreover, if a sales price for a home is set too high, the home may sit on the market for months costing a seller time, money, and opportunities to purchase a different home. Furthermore, if a sales price for a home is set too low, money can be lost on the sale. Sellers typically spend a great deal of resources analyzing sales of similar previously sold properties in the seller's market to estimate a value for a home or a final resale price for a home. Such tasks, however, are typically very time consuming and ultimately end up being inaccurate which result in sellers making poor decisions concerning the real-estate property sale.

### BRIEF DESCRIPTION OF THE DRAWINGS

To easily identify the discussion of any particular element or act, the most significant digit or digits in a reference number refer to the figure number in which that element is first introduced.

FIG. 1 is a block diagram showing an example networked system including a value gain generation system, according to some example embodiments.

FIG. 2 illustrates a valuation gain generation system, according to some example embodiments.

FIGS. 3-4 are flow charts illustrating aspects of a method for determining a valuation gain generation, according to some example embodiments.

FIG. 5 is a diagrammatic representation of a machine in the form of a computer system within which a set of instructions may be executed for causing the machine to perform any one or more of the methodologies discussed herein, in accordance with some example embodiments.

FIG. 6 is block diagram showing a software architecture within which the present disclosure may be implemented, in accordance with example embodiments.

### DETAILED DESCRIPTION

Systems and methods herein relate to generating a valuation gain for a property using seasonality calculations. A, listing for a property or real-estate property is a public announcement of the availability of a given real-estate property for purchase (e.g., announcing that a property is being put on sale). The public announcement may take various forms including posting pictures and/or details on one or more websites, newspapers, listing databases, communicating the offer for sale to one or more real-estate brokers or any other means to inform an interested party that the property is available for sale.

The systems available for determining a valuation amount of real-estate property requires a seller to manually analyze various country-based or jurisdiction-based statistics. But the statistics in these systems simply represent trends and averages that are not regularly updated and are simply determined based on a comparison of listing versus closing dates. The valuation amounts of properties provided in these systems does not represent other factors that may have impacted the valuation amount. As such, relying on these statistics to estimate valuation amount, results in determining an under-estimated or over-estimated valuation amount estimation that does not consider other factors (e.g., seasonality data, how many people are visiting the property, how long people spend during a given visit) that come up during the sale process. Namely, because the statistics are not regularly updated and do not represent sale conditions specific to different properties, the valuation amount is not generally accurate or revisited and adjusted during the sale process.

The disclosed embodiments improve the efficiency and accuracy of determining a valuation gain amount for a real estate property based on previously sold real-estate properties. For example, a system accesses data corresponding to previously sold real-estate property listings from one or more data sources, such as a market database (e.g., MLS data source). Using the accessed data, the system generates valuation data for each of the previously sold real-estate property listings for portions (e.g., a day, a week, every two weeks) of a specified time period (e.g., six months, a year). In one example, valuation data is generated for each week in a specified year. The system extracts seasonality data from the generated valuation data for each of the portions of the specified time period. The seasonality data is provided to a computing device and the system receives adjustments to the seasonality data from the client device. In one example, the adjustments relate to future real-estate property trends. Using the received adjustments, the system calculates a valuation gain amount for each of the portions of the specified time period for a new real estate property listing and generates a visual representing a graphical trend of the valuation gain amounts.

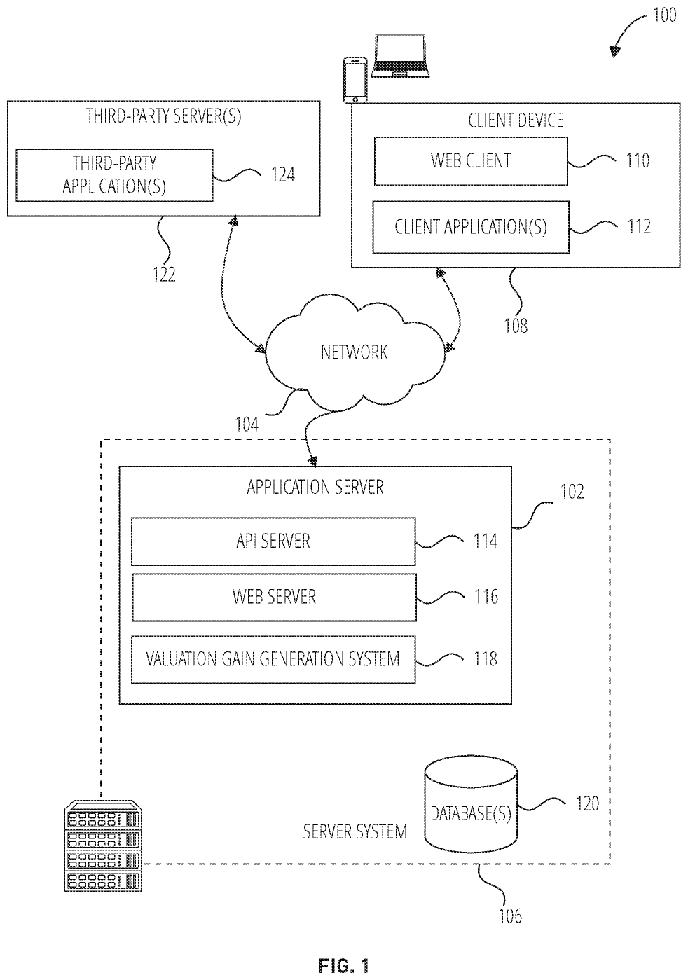

FIG. 1 is a block diagram illustrating a system 100, according to some example embodiments, configured to automatically determine the value of a real-estate property and provide the value to an interested entity (e.g., a user). The system 100 includes one or more client devices such as client device 108. The client device 108 comprises, but is not limited to, a mobile phone, desktop computer, laptop, portable digital assistants (PDA), smart phone, tablet, ultrabook, netbook, laptop, multi-processor system, microprocessor-based or programmable consumer electronic, game console, set-top box, computer in a vehicle, or any other communication device that a user may utilize to access the system 100. In some embodiments, the client device 108 comprises a display module (not shown) to display information (e.g., in the form of user interfaces). In further embodiments, the client device 108 comprises one or more of touch screens, accelerometers, gyroscopes, cameras, microphones, global positioning system (GPS) devices, and so forth. The client device 108 may be a device of a user that is used to access and utilize home buying services (e.g., obtain price prediction for home). For example, the client device 108 may be used to input information to request an automated offer on a subject real-estate property, to request a value of a subject real-estate property, to request mortgage cost information, to request affordability information (e.g., how much a user can afford to spend on a given real-estate property), to make an offer on a subject real-estate property, to receive and display various information about a subject real-estate property or a market (e.g., estimated value, valuation gain generation, seasonality data), and so forth.

For example, client device 108 is a device of a given user who would like to sell his or her subject real-estate property. Client device 108 accesses a website of the home buying and selling service (e.g., hosted by server system 106). The user inputs an address of the subject real-estate property and selects an option to receive an automated offer or value of the subject real-estate property in the website. Server system 106 receives the request and identifies comps (e.g., a plurality of real-estate properties) having similar attributes as the subject real-estate property. Server system 106 automatically retrieves characteristics of the subject real-estate property based on the address and search for comps within a predetermined distance (e.g., 1.2 miles) of the address of the subject real-estate property. Server system 106 then automatically computes a value for the subject real-estate property and provides the value to the client device 108 instantly or after a period of time (e.g., 24 hours). In some circumstances, server system 106 involves an operator of a website of the home buying and selling service using an operator device to review the value that was automatically computed before the value is returned to the client device 108. Client device 108 receives the value and provides an option to the user to complete the real-estate transaction.

For example, the user selects an option to complete the sale of the real-estate property. In response, server system 106 automatically generates a contract for sale of the subject real-estate property and allows the user to execute the contract to complete the sale. After the user executes the contract the subject real-estate property enters a pending status. Server system 106 may present a list of available closing dates to the user. Once the user selects the closing date, the subject real-estate property closes at the contract price on the closing date.

As another example, client device 108 is a device of a given user who would like to obtain a valuation gain amount of a real-estate property. Client device 108 accesses a website of the home buying and selling service (e.g., hosted by server system 106). The user inputs an address of the real-estate property, and, optionally, attaches an image of the real-estate property on the website. Server system 106 receives the user inputs and generates a valuation gain amount of the real-estate property. In one example, server system 106 computes the valuation gain amount based on valuation data relating to previously sold real-estate property listings, as described in further detail below. The valuation gain amount of the real-estate property is then provided by server system 106 to the client device 108.

One or more users may be a person, a machine, or other means of interacting with the client device 108. In example embodiments, the user may not be part of the system 100 but may interact with the system 100 via the client device 108 or other means. For instance, the user may provide input (e.g., touch screen input or alphanumeric input) to the client device 108 and the input may be communicated to other entities in the system 100 (e.g., third-party servers 130, server system 106, etc.) via the network 104. In this instance, the other entities in the system 100, in response to receiving the input from the user, may communicate information to the client device 108 via the network 104 to be presented to the user. In this way, the user interacts with the various entities in the system 100 using the client device 108.

The system 100 further includes a network 104. One or more portions of network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the public switched telephone network (PSTN), a cellular telephone network, a wireless network, a WiFi network, a WiMax network, another type of network, or a combination of two or more such networks.

The client device 108 may access the various data and applications provided by other entities in the system 100 via web client 110 (e.g., a browser) or one or more client applications 114. The client device 108 may include one or more client application(s) 112 (also referred to as “apps”) such as, but not limited to, a web browser, messaging application, electronic mail (email) application, an e-commerce site application, a mapping or location application, an online home buying and selling application, a real estate application, and the like.

In some embodiments, one or more client application(s) 112 are included in a given one of the client device 108, and configured to locally provide the user interface and at least some of the functionalities, with the client application(s) 112 configured to communicate with other entities in the system 100 (e.g., third-party third party server(s) 122, server system 106, etc.), on an as-needed basis, for data and/or processing capabilities not locally available (e.g., to access location information, to access market information related to homes, to authenticate a user, to verify a method of payment). Conversely, one or more client application(s) 112 may not be included in the client device 108, and then the client device 108 may use its web browser to access the one or more applications hosted on other entities in the system 100 (e.g., third-party server(s) 122, server system 106).

A server system 106 provides server-side functionality via the network 104 (e.g., the Internet or wide area network (WAN)) to one or more third party server(s) 122 and/or one or more client devices 110. The server system 106 includes an application program interface (API) server 120, a web server 116, and a valuation gain generation system 118, that may be communicatively coupled with one or more database(s) 120. The one or more database(s) 120 may be storage devices that store data related to users of the server system 106, applications associated with the server system 106, cloud services, housing market data, and so forth. The one or more database(s) 120 may further store information related to third party server(s) 122, third-party application(s) 124, client device 108, client application(s) 112, users, and so forth. In one example, the one or more database(s) 120 may be cloud-based storage.

The server system 106 may be a cloud computing environment, according to some example embodiments. The server system 106, and any servers associated with the server system 106, may be associated with a cloud-based application, in one example embodiment.

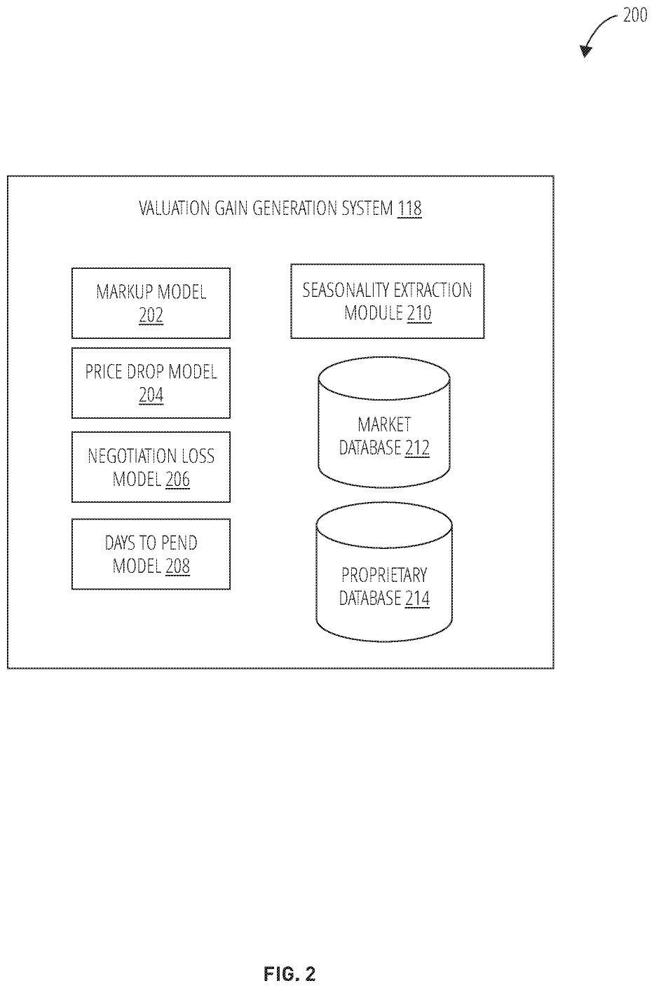

The server system 106 includes a valuation gain generation system 118. The valuation gain generation system 118 computes a valuation gain amount based on previously sold real-estate properties. In some examples, the valuation gain generation system 118 extracts seasonality data relating to the previously sold real-estate properties and calculates the valuation gain amount based on the extracted seasonality data. Further details of the valuation gain generation system 118 are provided below in connection with FIG. 2.

The system 100 further includes one or more third party server(s) 122. The one or more third-party server(s) 122 may include one or more third party application(s) 124. The one or more third-party application(s) 124, executing on third party server(s) 122 may interact with the server system 106 via API server 114 via a programmatic interface provided by the API server 114. For example, one or more the third-party applications 132 may request and utilize information from the server system 106 via the API server 114 to support one or more features or functions on a website hosted by the third party or an application hosted by the third party.

The third-party application(s) 124, for example, may provide software version analysis functionality that is supported by relevant functionality and data in the server system 106.

FIG. 2 is a block diagram 200 illustrating a valuation gain generation system 118 according to some example embodiments. The valuation gain generation system 118 is shown as including a markup model 202, price drop model 204, negotiation loss model 206, days to pend model 208, market database 212, a seasonality extraction module 210 and a proprietary database 214, all configured to communicate with each other (e.g., via bus, shared memory, or a switch). Any one or more of these systems may be implemented using one or more processors (e.g., by configuring such one or more processors to perform functions described for that system and hence may include one or more processors).

Any one or more of the systems described may be implemented using hardware alone (e.g., one or more of the processors of a machine) or a combination of hardware and software. For example, any system described of the valuation gain generation system 118 may physically include an arrangement of one or more of the processors (e.g., a subset of or among the one or more processors of the machine) configured to perform the operations described herein for that system. As another example, any system of the valuation gain generation system 118 may include software, hardware, or both, that configure an arrangement of one or more processors (e.g., among the one or more processors of the machine) to perform the operations described herein for that system. Accordingly, different systems of the valuation gain generation system 118 may include and configure different arrangements of such processors or a single arrangement of such processors at different points in time. Moreover, any two or more systems of the valuation gain generation system 118 may be combined into a single system, and the functions described herein for a single system may be subdivided among multiple systems. Furthermore, according to various example embodiments, systems described herein as being implemented within a single machine, database, or device may be distributed across multiple machines, databases, or devices.

The markup model 202 is configured to calculate a markup amount for a given property. A markup amount is a difference between an initial list price and a predicted valuation for all previously sold real-estate properties that were listed in a specific week. For example, a home may be marked up 5-7% (or any other amount) over what the home may be worth. A markup value may be based on a particular price range of real-estate property listings. In one example, the markup model 202 consists of a calibration function. The calibration function accounts for additional factors that may result in an adjusted markup amount. In one example, a first calibration function is applied for homes under a threshold value and a second calibration function is applied for homes that exceed a threshold value. For example, a first calibration function may be applied for homes under $300,000 and a second calibration function may be applied for homes over $300,000. The markup model 202 determines a plurality of markup amounts for a specified time period. For example, the markup model 202 may determine a plurality of markup amounts for a full year. In some examples the predicted valuation is stored in a proprietary database 214.

The price drop model 204 is configured to calculate an average price drop per day for all previously sold real-estate properties that were listed in a given week. For example, a real-estate property may be originally listed at $205,000 but the list price may be lowered to $200,000 if the home does not sell after one month (or some other predetermined period of time). In some examples, the average price drop pace is equal to: (Final List Price−Original List Price)/(Number of days listing was active). Accordingly, a home may be listed at an initial list price and the list price may be reduced (e.g., dropped) over time. The pace at which a price is dropped may be varied depending on the home and various factors.

The days to pend model 208 generates a days to pend amount using data from one or more database(s) 120. The days to pend amount is an amount of time it takes to sell a given property measured from the date the property is first listed for sale to the date a contract to purchase the property is executed (e.g., closing date). The days to pend amount may be provided as any interval or combination of intervals of time including number of days, weeks, months, years, seconds, minutes, hours, and so forth.

In one example, the days to pend amount is generated using a trained machine learning model. In some embodiments, the trained machine learning model models the log-odds of a clearance rate (e.g., the length of time it takes for a property to sell after being listed) in a given week t as a linear model computed in accordance with:

$$log ( \frac{{p}_{t} ( x )}{1 - {p}_{t} ( x )} ) = {β}_{0} + {β}_{1} {x}_{1} + . . . {β}_{n} {x}_{n}$$

Where B₀ is an intercept, B₁ and Bₙ are coefficients that are adjusted using linear regression for each feature x₁, x₂, xₙ etc. Where x₁, x₂, xₙ etc. correspond to one or more respective real-estate property activities or information n provided by the market database 212 as described below, and pₜ(x) corresponds to the days to pend amount for properties corresponding to features x₁, x₂, etc.

The price drop model 204 uses the days to pend amount generated by the days to pend model 208 to generate an adjusted average price drop per day.

The negotiation loss model 206 is configured to calculate the difference between the listing price and the contract price for all previously sold real-estate properties. The contract price represents a price the real-estate property ultimately sold for. In one example, the negotiation loss model 206 calculates the negotiation loss for all homes that went into a pending status in a specific week. For example, a real-estate property may be listed for $200,000 but ultimately sell for $195,000 in on market. The negotiation loss in this example is $5,000.

The seasonality extraction module 210 extracts seasonality data from the data generated (e.g., valuation data) by each of the markup model 202, the price drop model 204, the negotiation loss model 206, and the days to pend model 208. The seasonality data (e.g., seasonal variation, seasonality) are cycles that repeat regularly over time. A cycle structure is time series that may or may not be seasonal. If the cycle consistently repeats the same frequency, it is seasonal. Different types of seasonality include time of day, daily, weekly, monthly, yearly, and so forth. In some example embodiments, the seasonality extraction module 210 applies a statistical model to the data generated by each of the markup model 202, the price drop model 204, days to pend model 208, and the negotiation loss model 206 to generate seasonal trends representing the data. In some examples, the seasonal trends may be represented as seasonal graphical curves.

In one example, seasonality extraction module 210 extracts seasonality data from the markup model 202. For example, the seasonal trends extracted from the markup amounts represent that markup amounts are increased in the spring because spring may be a time period where homes sales are higher. In another example, the seasonality extraction module 210 extracts seasonality data from the price drop model 204. For example, the seasonal trends extracted from the average price drop per day represent that the price drop pace is slower for a particular month (e.g., December) because there is less demand in a particular market. In yet another example, the seasonality extraction module 210 extracts seasonality data from the negotiation loss model 206. For example, the seasonal trends extracted from the negotiation loss amounts represent higher negotiation loss amounts for homes sold in a lower buying season. The seasonality extraction module 210 may further extract seasonality data from the days to pend model 208. For example, the seasonal trends extracted from the days to pend amounts represent a higher days-to-pend amount for homes sold in a lower buying seasons. In some examples, the seasonality extraction module 210 extracts seasonal trends from clearance rate predictions generated by the trained machine learning model as described above to obtain a seasonally adjusted prediction for the days to pend amounts.

In one example, the market database 212 comprises real-estate property listing information. For example, third party server(s) 122 may include a multiple listing service (MLS) server. This service is publicly accessible to real-estate brokers nationwide. A real-estate broker inputs property information to the MLS server (e.g., price information, property attributes, listing date of a property, date contract to sell the property was executed, closing date of the property) to list the property for sale and to complete transactions for the property. Other brokers can access the MLS server to search and filter properties available for sale or that have been sold and select a given property to view. The MLS server may allow a real-estate broker to provide an offer to purchase a given property being listed for sale on behalf of a buyer. The MLS server may indicate whether and when a given property listing is pending indicating that an executed purchase and sale agreement between a buyer and seller of the real-estate property has been received. The MLS server may indicate whether and when a sale for a given property has been closed indicating that the legal transfer of title to the property from the seller to the buyer has been recorded in a government database.

The MLS server include a databases (e.g., market database 212) of real-estate properties. Characteristics of each property stored in the MLS server may also be provided. Characteristics include a location of the property, a school district, a tax rate, a home owners association rate, interior conditions (e.g., whether the property has been renovated, whether the property has stainless steel appliances, whether the property has a pool, whether the property has granite countertops), whether the property is characterized as new construction, whether the property has previously been occupied, and so forth. The information of the MLS server may be included as part of the market database 212. The MLS real-estate properties information may be used to search for comps to automatically determine a value of a subject real-estate property. The MLS real-estate properties information may include real-estate property activities.

For example, the real-estate property listing information may represent different types of real-estate property activities (e.g., a number of agent visits per day, a number of offers per visit, a number of views per day, a number of non-agent visits per day, a number of dislikes per view, a number of loss views per day, a visit duration, number of agent versus non-agent offers, or an amount of a given offer) associated with a plurality of real-estate properties is received by a server. The market database 212 may be cloud-based storage. The market database 212 may store real-estate property activity information including any one or more of number of agent visits per day, number of offers per visit, number of views per day (which can be based on a mobile computing platform used by the user to view the listing (e.g., iOS versus Android)), number of non-agent visits per day, number of dislikes per view, number of loss views per day, visit duration, number of agent versus non-agent offers, amount of a given offer, or any other information associated with a real-estate property listing (e.g., original list price (the price initially posted in the real-estate listing), original list price squared, hot zip code (representing a ranking of a list of zip codes where property sales are frequent), cold zip code (representing a ranking of a list of zip codes where property sales are infrequent), age of the property (e.g., whether the property is less than one year old, between 1 and 5 years old, between 5 and 10 years old or greater than 10 years old), length of time on the market before being sold (e.g., one week, two weeks, 4-8 weeks, or more than 8 weeks), price drop in a past week, discount from original list price (e.g., todays list price versus original list price), whether the property is hosted by server system 106 or hosted by a public real-estate server (e.g., an MLS server), property specific attributes (e.g., whether the property is on a busy road, a parking lot, a golf course). The information contained in the market database 212 may be publicly available (e.g., via third party server(s) 122).

The number of agent visits per day represents a number of real-estate brokers that physically visit a given real-estate property that is available for sale on a given day. Server system 106 may compute the number of agent visits per day in accordance with: sum(number of real-estate brokers that visit physically the property in a given week)/sum(number of days on the market in the given week—days since the property was listed in the given week). To perform this computation, a mobile computer may be physically located in the property that is listed for sale. As people come to physically visit the property, the people can input generic information such as their name and whether or not they are real-estate brokers and the date. This information is then sent from the mobile computer to the server system 106 along with a listing identifier or property identifier. Server system 106 then updates a running count of the number of agent (e.g., broker) and non-agent visitors that physically visit the property. Server system 106 also accesses information associated with the property including a date when the property was listed for sale in order to compute the number of agent visits per day. For example, server system 106 computes the number of agent visits per day for a given property based on a ratio of a total number of times one or more entities who are real-estate property brokers physically visit a given one of the plurality of real-estate properties and an amount of time elapsed since the given real-estate property was listed.

The number of non-agent visits per day represents a number of entities or people that are not real-estate brokers that physically visit a given real-estate property that is available for sale on a given day. Server system 106 may compute the number of non-agent visits per day in accordance with: sum (number of non-real-estate brokers that visit physically the property in a given week)/sum(number of days on the market in the given week—days since the property was listed in the given week). The server system 106 computes the number of non-agent visits per day in a similar manner as the number of agent visits per day.

The number of offers per visit represents a ratio of the number of offers to purchase the given real-estate property and the number of people that physically visited the property. Server system 106 may compute the number of offers per visit in accordance with: sum (number of offers in a given week)/sum(number of agent visits+number of non-real-estate broker visits in the given week). In some implementations, server system 106 access an MLS server to obtain offer information about a given property. Server system 108 uses the offer information (e.g., the number of offers submitted for a given property listing) along with the total number of visits, determined using the mobile computer that people who visit the property use to input information for server system 106 to track how many people visit the property, to compute the number of offers per visit. For example, server system 106 computes a number of offers per visit for each of the plurality of real-estate properties based on a ratio of a total number of offers to purchase a given one of the plurality of real-estate properties and a total number of times one or more entities physically visit the given real-estate property.

The number of views per day represents the number of people that accessed the publicly available real-estate listing through one or more websites. Server system 106 tracks IP numbers of the computers used to view the listing for a given property. Server system 106 accumulates the number of distinct IP numbers on a given day to compute the number of views on a given day.

The number of dislikes per view represents how many people select an option on the listing website indicating a level of dislike for the property. Server system 106 computes the number of dislikes per view by dividing the number of times a dislike option was selected for a given listing by the number of views per day.

The number of loss views per day indicates how many less people on each given day relative to a previous day are visiting the listing via the website. Server system 106 computes the number of loss views per day by comparing the number of distinct IP numbers that are detected that access a webpage that includes a listing for a given property on a given day with the number of distinct IP numbers that are detected on an adjacent next day. The difference in the two numbers of distinct IP numbers is provided and stored as the number of loss views per day.

The visit duration represents a length of time spent by a given entity or person physically visiting the real-estate property. In some implementations, after a given person finishes visiting a given property or physically leaves the property, the person inputs the time they left into the mobile computer at the property location. The mobile computer computes a difference between the time the person entered the property and the time the person left to provide to server system 106 the visit duration for a given person. In some implementations, server system 106 computes an average of the visit durations of each person who physically visited the property as the visit duration. The number of agent versus non-agent offers represents how many offers to purchase the property were received from real-estate brokers and how many were received from non-real-estate brokers. The amount of a given offer represents the dollar or currency value that a buyer is willing to pay for the given property.

The proprietary database 214 comprises information similar to information contained in the market database 212 but that may only be available internally (instead of publicly available) to server system 106 (and specifically to the valuation gain generation system 118). The proprietary database 214 may further comprise data used by the trained machine learning model described above in connection with the days to pend model 208.

In some examples, the seasonality extraction module 210 uses data from the market database 212 to extract seasonal trends. In some examples, the seasonality extraction module 210 uses data from the proprietary database 214 to extract seasonal trends. In some example, the seasonality extraction module 210 uses data from both the market database 212 and the proprietary database 214.

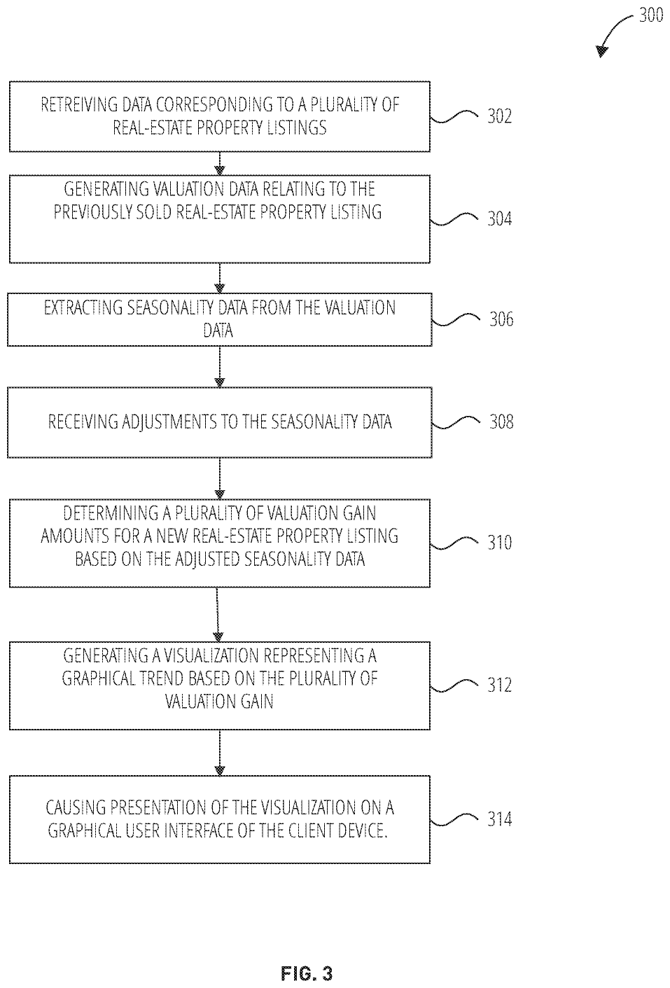

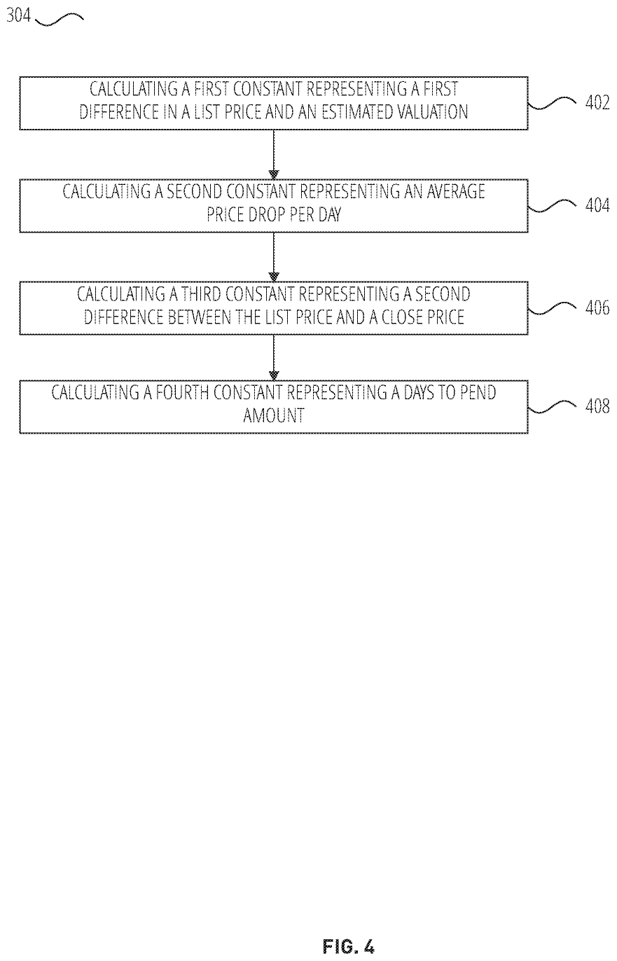

FIGS. 3-4 are flow diagram illustrating processes 300-400 for determining a valuation gain amount according to some example embodiments. The processes 300-400 may be embodied in computer-readable instructions for execution by one or more processors such that the operations of the processes 300-400 may be performed in part or in whole by the functional components of the server system 106; accordingly, the processes 300-400 are described below by way of example with reference thereto. However, in other embodiments at least some of the operations of the processes 300-400 may be deployed on various other hardware configurations. The processes 300-400 are therefore not intended to be limited to the server system 106 and can be implemented in whole, or in part, by any other component.

In operation 302, the valuation gain generation system 118 retrieves data corresponding to a plurality of previously sold real-estate property listings. For example, the valuation gain generation system 118 accesses one or more databases (e.g., market database 212) to retrieve the data corresponding to the plurality of previously sold real-estate property listings.

In operation 304, for each previously sold real-estate property, the valuation gain generation system 118 generates valuation data relating to the previously sold real-estate property listings for a plurality of portions of a specified time period. In one example, the generated valuation data comprises markup amounts, average price drop per day amounts, days to pend amounts, and negotiation loss amounts corresponding to each previously sold real-estate property for each portion of the specified time period. For example, the valuation gain generation system 118 generates markup amounts, average price drop per day amounts, days to pend amounts, and negotiation loss amounts corresponding to each previously sold real-estate property for each portion of the specified time period. For example, the valuation gain generation system 118 may calculate valuation data relating to the previously sold real-estate properties weekly over the span of one year. In some examples the specified time period may be represented in days, weeks, months, years, and so forth. In some examples, the portions of the specified time periods may be represented in days, weeks, months, years, and the like. Further details regarding operation 304 are described below in connection with FIG. 4.

In operation 306 the valuation gain generation system 118 extracts seasonality data from the valuation data for each portion of the plurality of portions. For example, the valuation gain generation system 118 uses the seasonality extraction module 210 to extract seasonality data from the valuation data. In some examples, the valuation gain generation system 118 applies a statistical model to the valuation data.

In some examples the statistical model is a statistical task that deconstructs a time series into several components, each representing one of the underlying categories of patterns. For example, the statistical model may deconstruct the valuation data into a trend component, seasonality component and error component. A trend is observed when there is a decreasing or increasing slope in the time series. Seasonality is observed when there is a distinct repeated pattern observed between time intervals, the repeated patterns due to seasonal factors. A time series may have at least one of a trend and seasonality. The time series may be modeled as an additive time series (e.g., trend+seasonality+error) or a multiplicative time series (trend*seasonality*error). To detect the underlying trend, the statistical model may “smooth” the time series using a centered moving average. A moving average is a technique to understand trends in a dataset. The moving average is calculated by creating a series of averages of different subsets of the full dataset. Once the statistical model identifies the trend, the statistical model may remove the previously calculated trend from the time series. Removing the trend from the time series will expose seasonality of the time series. Using the detected time series, the statistical model may compute the average seasonality.

In some examples, the seasonality extraction module 210 applies a convolutional filter to the valuation data to extract the seasonal component of the data. The extracted seasonality component is represented in the same units as the valuation data.

In response to applying the statistical model to the valuation data, the valuation gain generation system 118 generates a plurality of seasonal curves using the statistical model. The plurality of seasonal curves may represent seasonal trends relating to the valuation data (e.g., markup amounts, price drop amounts, negotiation loss amounts, days to pend amounts). For example, the valuation gain generation system 118 may generate a first curve representing seasonality data for the markup amounts, a second curve representing seasonality data for the price drop amounts, a third curve representing seasonality data for the negotiation loss amounts, and a fourth curve representing seasonality data for the days to pend amounts.

In operation 308, the valuation gain generation system 118 receives adjustments to the seasonality data. The adjustments may relate to future real-estate property trends. Data relating to the future real-estate property trends may be stored in the market database 212 or the proprietary database 214. The adjustments may further represent macroeconomic business indicators, real-estate market trends, or proprietary data, such as the proprietary data stored in proprietary database 214. In some examples, human experts in the real-estate industry provide the adjustments to the seasonality data from a client device associated with the human experts. In this example, the valuation gain generation system 118 receives the adjustments from the client device.

In operation 310, the valuation gain generation system 118 determines a plurality of valuation gain amounts for a new real-estate property listing based on the adjusted seasonality data. In some examples the valuation gain amounts may be calculated based on a weighted sum of the valuation data. For example, the valuation gain amount is calculated by: (Markup Amount)+((Price Drop Amount)*(Days to Pend Amount))+(Negotiation Loss Amount).

In operation 312, the valuation gain estimation system 118 generates a visualization representing the valuation gain amounts for the specified time period. In one example, the visualization is in form of a graphical trend of the valuation gain amounts across the specified time period.

In operation 314, the valuation gain generation system 118 causes presentation of the graphical trend of the valuation gain amounts across the specified time period on a graphical user interface of the client device. The visualization of the valuation gain amounts may be published on a real-estate buying and selling online platform for public use.

FIG. 4 is a flow chart showing further details for operation 304 for calculating valuation data for previously sold real-estate property listings.

In operation 402, the valuation gain generation system 118 calculates, for each listing of the plurality of real-estate property listings, a first constant (e.g., a markup amount) representing a difference in a list price and an estimated valuation. The first constant may be calculated by the markup model 202 for each portion of the specified time period. For example, the first constant is a dollar value (e.g., $5,000), a percent (4%), or the like, representing the markup amount for each listing of the plurality of real-estate property listings.

In operation 404, the valuation gain generation system 118 calculates, for each listing of the plurality of real-estate property listings, a second constant representing an average price drop per day. The second constant may be calculated by the price drop model 204 for each portion of the specified time period. For example, the second constant is a dollar value (e.g., $200), a percent (2%), or the like, representing an average price drop per day that can be weighted (adjusted) by the days to pend amount.

In operation 406, the valuation gain generation system 118 calculates, for each listing of the plurality of real-estate property listings, a third constant representing a difference between the list price and the close price (e.g., a negotiation loss amount). The third constant may be calculated by the negotiation loss model 206 for each portion of the specified time period. For example, the third constant is a dollar value (e.g., $4500), a percent (10%), or the like, representing the negotiation loss amount.

In operation 408, the valuation gain generation system 118 calculates, for each listing of the plurality of real-estate property listings, a fourth constant representing a days to pend amount. The fourth constant may be calculated by the days to pend model 208. The second constant may be weighted by the days to pend amount calculated by the days to pend model 208

In this way, the valuation gain generation system 118 generates the valuation data comprising the first constant, the second constant, and the third constant. In one example, the valuation gain amount is a sum of each of the first constant, second constant and the third constant. Accordingly, a valuation gain amount may represent a difference between an initial valuation amount and a future valuation amount.

The description herein includes systems, methods, techniques, instruction sequences, and computing machine program products that embody illustrative embodiments of the disclosure. In the following description, for the purposes of explanation, numerous specific details are set forth in order to provide an understanding of various embodiments. It will be evident, however, to those skilled in the art, that embodiments may be practiced without these specific details. In general, well-known instruction instances, protocols, structures, and techniques are not necessarily shown in detail.

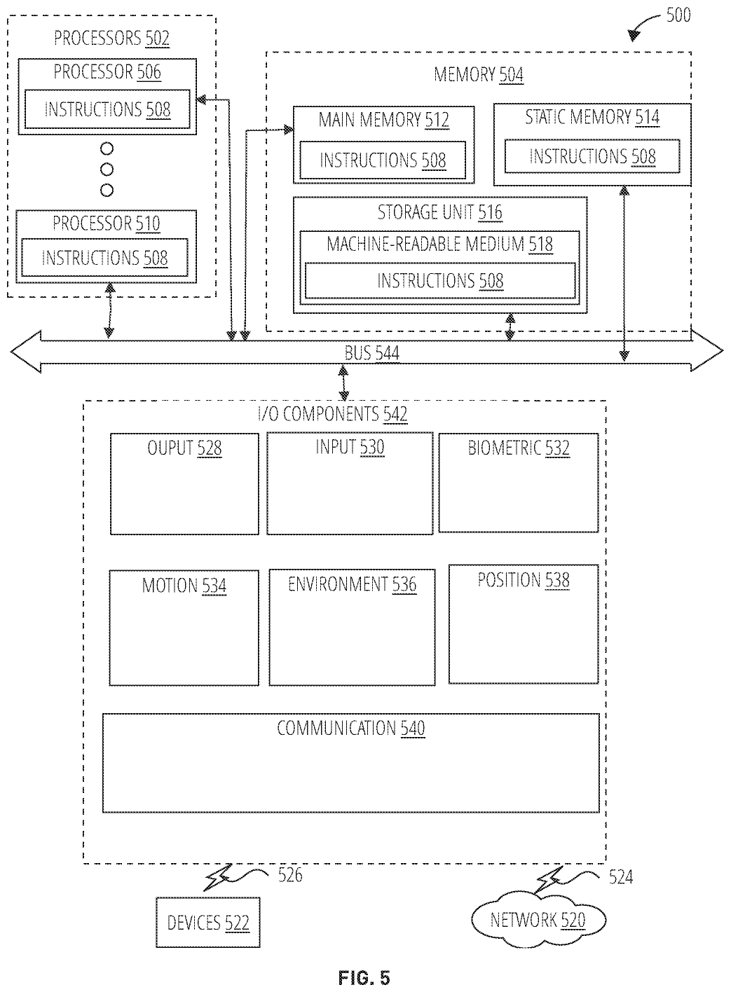

FIG. 5 is a diagrammatic representation of the machine 500 within which instructions 508 (e.g., software, a program, an application, an applet, an app, or other executable code) for causing the machine 500 to perform any one or more of the methodologies discussed herein may be executed. For example, the instructions 508 may cause the machine 500 to execute any one or more of the methods described herein. The instructions 508 transform the general, non-programmed machine 500 into a particular machine 500 programmed to carry out the described and illustrated functions in the manner described. The machine 500 may operate as a standalone device or may be coupled (e.g., networked) to other machines. In a networked deployment, the machine 500 may operate in the capacity of a server machine or a client machine in a server-client network environment, or as a peer machine in a peer-to-peer (or distributed) network environment. The machine 500 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 508, sequentially or otherwise, that specify actions to be taken by the machine 500. Further, while only a single machine 500 is illustrated, the term “machine” shall also be taken to include a collection of machines that individually or jointly execute the instructions 508 to perform any one or more of the methodologies discussed herein.

The machine 500 may include processors 502, memory 504, and I/O components 542, which may be configured to communicate with each other via a bus 544. In an example embodiment, the processors 502 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 506 and a processor 510 that execute the instructions 508. The term “processor” is intended to include multi-core processors that may comprise two or more independent processors (sometimes referred to as “cores”) that may execute instructions contemporaneously. Although FIG. 5 shows multiple processors 502, the machine 500 may include a single processor with a single core, a single processor with multiple cores (e.g., a multi-core processor), multiple processors with a single core, multiple processors with multiples cores, or any combination thereof.

The memory 504 includes a main memory 512, a static memory 514, and a storage unit 516, both accessible to the processors 502 via the bus 544. The main memory 504, the static memory 514, and storage unit 516 store the instructions 508 embodying any one or more of the methodologies or functions described herein. The instructions 508 may also reside, completely or partially, within the main memory 512, within the static memory 514, within machine-readable medium 518 within the storage unit 516, within at least one of the processors 502 (e.g., within the processor's cache memory), or any suitable combination thereof, during execution thereof by the machine 500.

The I/O components 542 may include a wide variety of components to receive input, provide output, produce output, transmit information, exchange information, capture measurements, and so on. The specific I/O components 542 that are included in a particular machine will depend on the type of machine. For example, portable machines such as mobile phones may include a touch input device or other such input mechanisms, while a headless server machine will likely not include such a touch input device. It will be appreciated that the I/O components 542 may include many other components that are not shown in FIG. 5. In various example embodiments, the I/O components 542 may include output components 528 and input components 530. The output components 528 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 530 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 542 may include biometric components 532, motion components 534, environmental components 536, or position components 538, among a wide array of other components. For example, the biometric components 532 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 534 include acceleration sensor components (e.g., accelerometer), gravitation sensor components, rotation sensor components (e.g., gyroscope), and so forth. The environmental components 536 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 538 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 542 further include communication components 540 operable to couple the machine 500 to a network 520 or devices 522 via a coupling 524 and a coupling 526, respectively. For example, the communication components 540 may include a network interface component or another suitable device to interface with the network 520. In further examples, the communication components 540 may include wired communication components, wireless communication components, cellular communication components, Near Field Communication (NFC) components, Bluetooth® components (e.g., Bluetooth® Low Energy), Wi-Fi components, and other communication components to provide communication via other modalities. The devices 522 may be another machine or any of a wide variety of peripheral devices (e.g., a peripheral device coupled via a USB).

Moreover, the communication components 540 may detect identifiers or include components operable to detect identifiers. For example, the communication components 540 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 540, such as location via Internet Protocol (IP) geolocation, location via Wi-Fi® signal triangulation, location via detecting an NFC beacon signal that may indicate a particular location, and so forth.

The various memories (e.g., memory 504, main memory 512, static memory 514, and/or memory of the processors 502) and/or storage unit 516 may store one or more sets of instructions and data structures (e.g., software) embodying or used by any one or more of the methodologies or functions described herein. These instructions (e.g., the instructions 508), when executed by processors 502, cause various operations to implement the disclosed embodiments.

The instructions 508 may be transmitted or received over the network 520, using a transmission medium, via a network interface device (e.g., a network interface component included in the communication components 540) and using any one of a number of well-known transfer protocols (e.g., hypertext transfer protocol (HTTP)). Similarly, the instructions 508 may be transmitted or received using a transmission medium via the coupling 526 (e.g., a peer-to-peer coupling) to the devices 522.

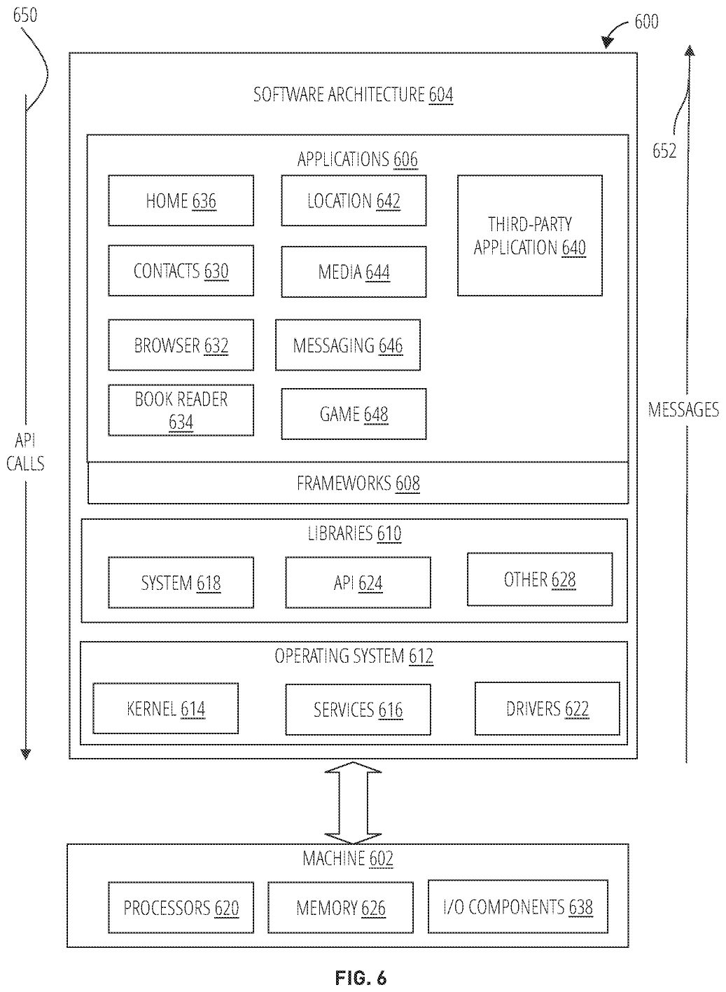

FIG. 6 is a block diagram 600 illustrating a software architecture 604, which can be installed on any one or more of the devices described herein. The software architecture 604 is supported by hardware such as a machine 602 that includes processors 620, memory 626, and I/O components 638. In this example, the software architecture 604 can be conceptualized as a stack of layers, where each layer provides a particular functionality. The software architecture 604 includes layers such as an operating system 612, libraries 610, frameworks 608, and applications 606. Operationally, the applications 606 invoke API calls 650 through the software stack and receive messages 652 in response to the API calls 650.

The operating system 612 manages hardware resources and provides common services. The operating system 612 includes, for example, a kernel 614, services 616, and drivers 622. The kernel 614 acts as an abstraction layer between the hardware and the other software layers. For example, the kernel 614 provides memory management, processor management (e.g., scheduling), component management, networking, and security settings, among other functionality. The services 616 can provide other common services for the other software layers. The drivers 622 are responsible for controlling or interfacing with the underlying hardware. For instance, the drivers 622 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

The libraries 610 provide a low-level common infrastructure used by the applications 606. The libraries 610 can include system libraries 618 (e.g., C standard library) that provide functions such as memory allocation functions, string manipulation functions, mathematic functions, and the like. In addition, the libraries 610 can include API libraries 624 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 610 can also include a wide variety of other libraries 628 to provide many other APIs to the applications 606.

The frameworks 608 provide a high-level common infrastructure that is used by the applications 606. For example, the frameworks 608 provide various graphical user interface (GUI) functions, high-level resource management, and high-level location services. The frameworks 608 can provide a broad spectrum of other APIs that can be used by the applications 606, some of which may be specific to a particular operating system or platform.

In an example embodiment, the applications 606 may include a home application 636, a contacts application 630, a browser application 632, a book reader application 634, a location application 642, a media application 644, a messaging application 646, a game application 648, and a broad assortment of other applications such as a third-party application 640. The e applications 606 are programs that execute functions defined in the programs. Various programming languages can be employed to create one or more of the applications 606, structured in a variety of manners, such as object-oriented programming languages (e.g., Objective-C, Java, or C++) or procedural programming languages (e.g., C or assembly language). In a specific example, the third-party application 640 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 640 can invoke the API calls 650 provided by the operating system 612 to facilitate functionality described herein.

What is claimed is:

1. A method comprising:
retrieving, from one or more data sources, data corresponding to a plurality of previously sold real-estate property listings;
for each previously sold real-estate property listing of the plurality of previously sold real-estate property listings and for each portion of a plurality of portions of a specified time period:
generating valuation data relating to the previously sold real-estate property listing by performing operations comprising:
calculating a first constant representing a difference in a list price and an estimated valuation for the previously sold real-estate property listing;
calculating a second constant representing an average price drop per day for the previously sold real-estate property listing;
calculating a third constant representing a difference between the list price and a close price for the previously sold real-estate property listing; and
calculating a fourth constant representing a days to pend amount for the previously sold real-estate property listing;
extracting seasonality data from the generated valuation;
providing the extracted seasonality data to a client device;
receiving, from the client device, adjustments to the seasonality data, the adjustments relating to future real-estate property listing trends;
using the received adjustments to the seasonality data, generating a valuation gain amount for a new real-estate property listing for each portion of the plurality of portions of the specified time period to generate a plurality of valuation gain amounts;
generating a visualization representing a graphical trend based on the plurality of valuation gain amounts; and
causing presentation of the visualization on a graphical user interface of the client device.

2. The method of claim 1, wherein the seasonality data represents seasonal trends from the valuation data.

3. The method of claim 1, wherein extracting the seasonality data from valuation data further comprises:
applying a statistical model to the valuation data; and
generating a plurality of seasonality curves using the statistical model.

4. The method of claim 3, wherein the plurality of seasonality curves comprises:
a first curve representing seasonality data for the first constant;
a second curve representing seasonality data for the second constant;
a third curve representing seasonality data for the third constant; and
a fourth curve representing seasonality data for the fourth constant.

5. The method of claim 1, wherein the future real estate property trends are based on at least a first set of market data retrieved from a market database and a second set of proprietary data retrieved from a proprietary database.

6. The method of claim 1, wherein the valuation gain amount is a difference between an initial valuation amount and a future valuation amount.

7. The method of claim 1, wherein the second constant is weighted by the fourth constant.

8. A computing apparatus, the computing apparatus comprising:
a processor; and
a memory storing instructions that, when executed by the processor, configure the apparatus to perform operations comprising:
retrieving, from one or more data sources, data corresponding to a plurality of previously sold real-estate property listings;
for each previously sold real-estate property listing of the plurality of previously sold real-estate property listings and for each portion of a plurality of portions of a specified time period:
generating valuation data relating to the previously sold real-estate property listing by performing operations comprising:
calculating a first constant representing a difference in a list price and an estimated valuation for the previously sold real-estate property listing;
calculating a second constant representing an average price drop per day for the previously sold real-estate property listing; and
calculating a third constant representing a difference between the list price and a close price for the previously sold real-estate property listing;
calculating a fourth constant representing a days to pend amount for the previously sold real-estate property listing;
extracting seasonality data from the generated valuation;
providing the extracted seasonality data to a client device;
receiving, from the client device, adjustments to the seasonality data, the adjustments relating to future real-estate property listing trends;
using the received adjustments to the seasonality data, generating a valuation gain amount for a new real-estate property listing for each portion of the plurality of portions of the specified time period to generate a plurality of valuation gain amounts;
generating a visualization representing a graphical trend based on the plurality of valuation gain amounts; and
causing presentation of the visualization on a graphical user interface of the client device.

9. The computing apparatus of claim 8, wherein the seasonality data represents seasonal trends from the valuation data.

10. The computing apparatus of claim 8, wherein extracting the seasonality data from valuation data further comprises:
applying a statistical model to the valuation data; and
generating a plurality of seasonality curves using the statistical model.

11. The computing apparatus of claim 10, wherein the plurality of seasonality curves comprises:
a first curve representing seasonality data for the first constant;
a second curve representing seasonality data for the second constant;
a third curve representing seasonality data for the third constant; and
a fourth curve representing seasonality data for the fourth constant.

12. The computing apparatus of claim 8, wherein the future real estate property trends are based on at least a first set of market data retrieved from a market database and a second set of proprietary data retrieved from a proprietary database.

13. The computing apparatus of claim 8, wherein the valuation gain amount is a difference between an initial valuation amount and a future valuation amount.

14. The computing apparatus of claim 8, wherein the second constant is weighted by the fourth constant.

15. A non-transitory computer-readable storage medium, the computer-readable storage medium including instructions that when executed by a computer, cause the computer to perform operations comprising:
retrieving, from one or more data sources, data corresponding to a plurality of previously sold real-estate property listings;
for each previously sold real-estate property listing of the plurality of previously sold real-estate property listings and for each portion of a plurality of portions of a specified time period:
generating valuation data relating to the previously sold real-estate property listing by performing operations comprising:
calculating a first constant representing a difference in a list price and an estimated valuation for the previously sold real-estate property listing;
calculating a second constant representing an average price drop per day for the previously sold real-estate property listing; and
calculating a third constant representing a difference between the list price and a close price for the previously sold real-estate property listing;
calculating a fourth constant representing a days to pend amount for the previously sold real-estate property listing;
extracting seasonality data from the generated valuation;
providing the extracted seasonality data to a client device;
receiving, from the client device, adjustments to the seasonality data, the adjustments relating to future real-estate property listing trends;
using the received adjustments to the seasonality data, generating a valuation gain amount for a new real-estate property listing for each portion of the plurality of portions of the specified time period to generate a plurality of valuation gain amounts;
generating a visualization representing a graphical trend based on the plurality of valuation gain amounts; and
causing presentation of the visualization on a graphical user interface of the client device.

16. The computer-readable storage medium of claim 15, wherein the seasonality data represents seasonal trends from the valuation data.

17. The computer-readable storage medium of claim 15, wherein extracting the seasonality data from valuation data further comprises:
applying a statistical model to the valuation data; and
generating a plurality of seasonality curves using the statistical model.

18. The computer-readable storage medium of claim 17, wherein the plurality of seasonality curves comprises:
a first curve representing seasonality data for the first constant;
a second curve representing seasonality data for the second constant;
a third curve representing seasonality data for the third constant; and
a fourth curve representing seasonality data for the fourth constant.

19. The computer-readable storage medium of claim 15, wherein the future real estate property trends are based on at least a first set of market data retrieved from a market database and a second set of proprietary data retrieved from a proprietary database.

20. The computer-readable storage medium of claim 15, wherein the valuation gain amount is a difference between an initial valuation amount and a future valuation amount.
